(19) United States
(12) Patent Application Publication
(10) Pub. No.: US 2012/0312339 A1
(43) Pub. Date: Dec. 13, 2012

(54) Clarifier tank sludge removal apparatus

(75) Inventors: Gary Pashaian, Monroe, MI (US); Adam Pashaian, Monroe, MI (US); William Boyle, Waukesha, WI (US)

(73) Assignee: Monroe Environmental Corporation, Monroe, MI (US)

(21) Appl. No.: 13/317,303

(22) Filed: Oct. 14, 2011

Related U.S. Application Data
(60) Provisional application No. 61/520,494, filed on Jun. 10, 2011.

(51) Int. Cl. B08B 9/08

(52) U.S. Cl. 134/166 R

(57) ABSTRACT

A sludge removal system for removing sludge from a clarifier tank is disclosed. The system comprises a movable sludge intake manifold, a stationary sludge outlet conduit and one or more conduits dynamically and fluidically connecting the manifold and the sludge outlet conduit, even as the manifold moves relative to the stationary sludge outlet. One or more of the conduits between the manifold and the outlet are connected in the system through rotatable conduit connectors which is part of the dynamic connection mentioned above. Improved sludge intake constructions are also disclosed.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

1. Field of the Invention

The invention relates to liquid treatment and particularly to the removal of solids, i.e., sludge, from liquid. In liquid clarifiers, solids or sediment particles settle to the bottom of a treatment tank or basin where they may form a loose and liquid filled sludge layer at or on the bottom of a treatment tank. This layer is often referred to as a “sludge blanket”. In order to prevent sludge layer from interfering with the operation of a clarifier, a portion of the sludge layer is intermittently or continuously removed from a sedimentation basin of the clarifier.

The sludge blanket can be removed from a basin by head pressure (gravity) or by pumping, i.e., vacuum. Various sludge collection mechanisms have been developed to remove sludge more efficiently.

2. Description of the State of the Art

There are existing mechanisms that collect sludge. One such mechanism uses flexible hoses to remove, as by suction, the sludge from a basin. The flexible hoses are considered to be problematic because, at times, the hoses float when a basin is drained and then refilled, due to air trapped in the hose. Flexible hoses have a way of interfering with other components in a clarifier.

One commercially available sludge collection system does not require flexible hoses. This system uses a telescoping main sludge collection pipe with the sludge collecting manifolds directly connected to the side of this main pipe. Some of the details of this system can be seen in U.S. Pat. No. 7,159,724. One disadvantage attendant to this system is that, when the telescoping main sludge pipe is in its closed or contracted position, sludge that is collected enters a main outer pipe and must flow a long distance in a long passageway between the outer pipe and an inner pipe and then, upon reaching the end of that passageway, must reverse direction and flow a great distance in the opposite direction to the outlet. This tortuous path can create low flow zones where sludge may accumulate. Longer flow paths associated with this system may cause enough friction to lead to a need for higher capacity pumps or vacuum systems.

A “sludge robot” is disclosed in U.S. Pat. No. 4,381,237. A sludge inlet in the form of an angle piece (9) is connected through several other angle pieces. Pairs of angle pieces are connected by motor couplings (2). In some manner, the sludge inlet traverses a portion of the bottom of a tank. The system includes a micro dator which is programmed according to the size and shape of the tank bottom.

U.S. Pat. No. 6,497,249 discloses a sludge removal system including a reciprocating manifold which continuously traverses the bottom of the tank and collects sludge and delivers it to a fixed outlet. Movement of the manifold within the tank is effected by various hydraulic means including, as shown in FIGS. 1 and 2, liquid pressure acting on the face of a portion of a sliding seal and also, as shown in FIGS. 3 through 5, liquid pressure operating a liquid driven motor.

It is an object of the invention to provide an improved sludge removal system for removing sludge from a settling tank.

It is a further object of the invention to provide an improved sludge removal system in which sludge is removed by flowing through a path which does not reverse directions on the way to the sludge outlet.

It is still another object of the invention to provide a system in which sludge travels a non-tortuous path as it travels to the sludge inlet to the sludge outlet.

It is a further object of the invention to provide an improved sludge removal system which does not include flexible members such as hoses and the like.

It is yet another object of this invention to provide an improved sludge removal system which is compact and provides for unrestricted movement of a sludge intake manifold.

These and other objects and advantages of the present invention shall be apparent from the following detailed description with reference, therein, to the several drawing figures.

### BRIEF DESCRIPTION OF THE SEVERAL VIEWS OF THE DRAWING

FIG. 1 is a plan view of a settling tank or basin in which there is mounted a sludge removal apparatus according to the invention;

FIG. 2 is a side view of an embodiment of a rotating conduit connector suitable for use in the present invention.

FIG. 3 is a side view in cross section of another rotating conduit connector suitable for use in the present invention.

FIG. 4 is a side view of yet another rotating conduit connector suitable for use in the present invention.

FIG. 5 is a top view of the rotating conduit connector shown in FIG. 4.

FIG. 6 is a perspective view of a sludge inlet through which sludge would flow as it is removed from the liquid in the basin.

FIG. 7 is a stylized side view of an embodiment of the sludge removal apparatus corresponding generally with the apparatus shown in FIG. 1.

FIG. 8 is a plan view of sludge removal apparatus according to another embodiment of the invention;

FIG. 9 is a plan view of sludge removal apparatus according to another embodiment of the invention;

FIG. 10 is a plan view of sludge removal apparatus according to another embodiment of the invention;

FIG. 11 is a plan view of sludge removal apparatus according to another embodiment of the invention;

FIG. 12 is a side view of a manifold arm conduit showing an embodiment of a sludge inlet through which sludge would enter the sludge removal apparatus.

FIG. 13 is an end view of a manifold arm conduit showing the sludge inlet illustrated in FIG. 12.

### DETAILED DESCRIPTION OF REPRESENTATIVE EMBODIMENTS OF THE INVENTION

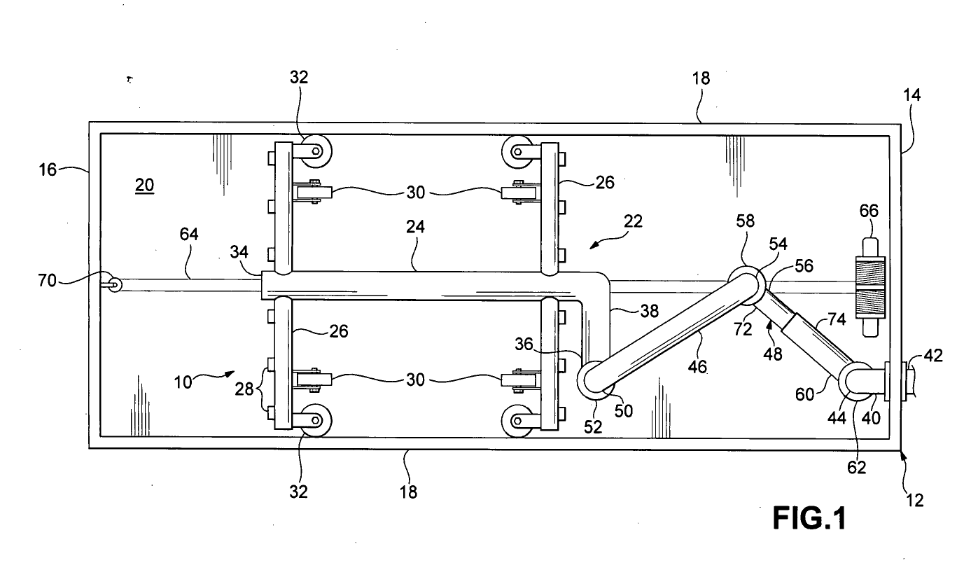

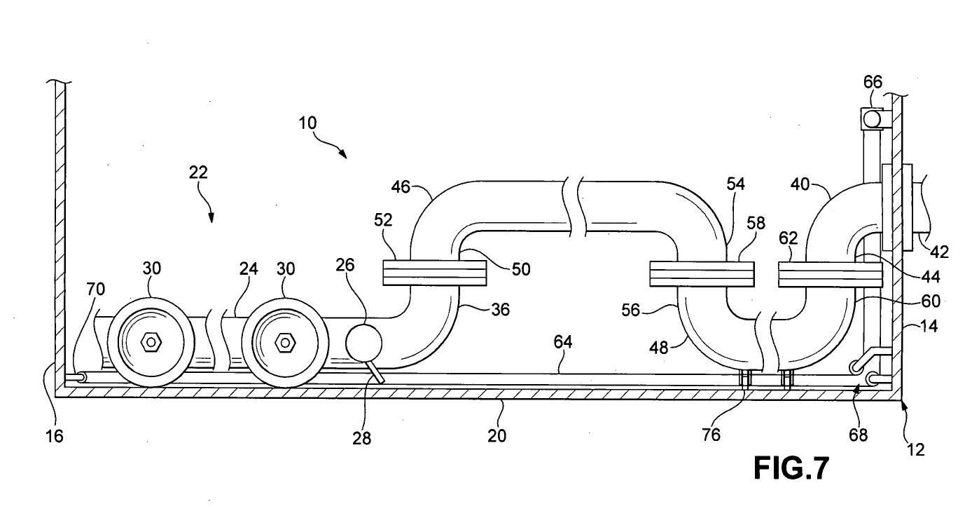

Referring now to FIGS. 1 and 7, a sludge removal apparatus according to the invention is indicated generally at 10. The apparatus 10 is in a basin or settling tank 12 which has a front wall 14 and a rear wall 16. Tank side walls 18 extend in the longitudinal direction of the tank 12 and so does a tank bottom 20. Throughout the drawing figures, the same reference numbers are used to designate like elements.

The apparatus 10 comprises a sludge collection manifold 22 which is supported above the basin bottom 20 for reciprocating movement towards and away from the rear wall 16. The manifold 22 comprises a longitudinally extending manifold conduit 24 and manifold arm conduits 26 which extend laterally outwardly from the conduit 24. The manifold conduit 24 is in fluid communication with the manifold arm conduits 26 which, in turn, are in fluid communication with the interior of the tank 12 through openings in the arms 26. Example of such openings in the arms 26 are shown in, and described below in connection with, FIGS. 6, 12 and 13. Sludge scrapers 28 may be provided on the manifold arm conduits 26 to facilitate the flow of sludge up from the tank bottom 20 and into the manifold arm conduits 26.

The manifold 22 is supported above the floor 20 of the tank 12 on wheels 30 which may be attached to the manifold arm conduits 26, as shown in FIGS. 1 and 7. The wheels 30 facilitate the reciprocation of the manifold 22 while supporting the manifold 22. Side wheels 32 may also be provided on the manifold 22 to cooperate with the side walls 18 when the manifold 22 is reciprocating. Cooperation between the wheels 32 and the side walls 18 helps to maintain the manifold 22 in parallel alignment with the side walls 18 of the tank 12 and the wheels 32 help to minimize friction between the manifold 22 and the walls 18.

A first end 34 of the longitudinally extending manifold conduit 24 is closed. Adjacent to a second end 36 of the longitudinally extending manifold conduit 24, there is a laterally extending portion 38 of the longitudinally extending manifold conduit 24. In the apparatus 10 shown in FIGS. 1 and 7, a sludge outlet conduit 40 has a first end 42 that is outside of the tank 12 and a second end 44 that is inside of the tank. The conduit 40 is the outlet in the apparatus 10 through which sludge leaves the tank 12. The sludge outlet may be fixed relative to the wall 14, as shown, or fixed relative to any other part of the basin 12. A conduit 46 and a conduit 48 provide for fluid communication between outlet conduit 40 and the manifold conduit 24.

A first end 50 of the conduit 46 is rotatably connected to the second end 36 of the manifold conduit 24 through a rotating conduit connector 52 which provides fluid communication between the conduits 24 and 46. A second end 54 of the conduit 46 is rotatably connected to a first end 56 of the conduit 48 through a rotating conduit connector 58 which provides fluid communication between the conduits 46 and 48. A second end 60 of the conduit 48 is rotatably connected to the second end 44 of the sludge outlet conduit 40 through a rotating conduit connector 62 which provides fluid communication between the conduits 48 and 40.

A flow path is thus provided so that sludge can flow from the tank 12 into the manifold 22 through openings in the manifold arm conduits 26 and out of the tank 12 through outlet conduit 40. The flow path is described below. The motive force for causing the flow of sludge may be provided by a vacuum, or a pump, or by gravity owing to the head of liquid in the basin 12, or by any other suitable source.

Sludge that has settled to the bottom of the basin 12 enters the manifold arm conduits 26 and flows into and through the longitudinally extending manifold conduit 24. The sludge in the manifold conduit 24 is conducted out of the basin 12 by flowing from the conduit 24 into and through the rotating conduit connector 52, into and through the conduit 46, into and through the rotating conduit connector 58, into and through the conduit 48, into and through the rotating conduit connector 62 and into and through the sludge outlet conduit 40 and out of the basin 12.

The longitudinal position of the manifold 22 within the basin 12 is adjustable and it is controlled through the operation of a positioning device. In the embodiment shown in the drawing figures, the positioning device includes a cable 64 that is attached to the manifold 22. A positioning winch system 66 is supported on the front wall 14, near the top. The cable 64 runs from the winch system 66, down the wall 14 and around a pulley in a pulley station 68, towards the rear wall 16, around a pulley 70, back towards the front wall 14, around a pulley in the pulley system 68 and back up to the winch system 66. Operation of the winch system will move the cable 64 and, with it, the manifold 24 which is connected to the cable 64.

As the manifold 22 moves towards the rear wall 16, the distance increases between the end 36 of the manifold conduit 24, on the one hand, and the end 44 of the outlet conduit 40, on the other hand. As the manifold 22 moves towards the front wall 14, the distance decreases between the end 36 of the manifold conduit 24, on the one hand, and the end 44 of the outlet conduit 40, on the other hand. Notwithstanding these changes in the distance between the conduits 24 and 40, fluid communication between them is maintained through the conduits 46 and 48 as they reorient themselves to span the distance between the conduits 24 and 40 which is small when they are closest to each other and which is big when they are furthest apart from each other. This conduit reorientation is facilitated by the rotating conduit connectors 52, 58 and 62. Connector 52 maintains fluid communication between the conduits 24 and 46 while permitting relative rotation between them. Connector 58 maintains fluid communication between the conduits 46 and 48 while permitting relative rotation between them. Connector 62 maintains fluid communication between the conduits 48 and 40 while permitting relative rotation between them. This creates a kind of a scissor action between conduits 46 and 48, as well as between conduits 24 and 46, and also between conduits 48 and 40.

As can be seen in FIG. 1, conduit 48 is a telescoping conduit with an inner tube 72 and an outer tube 74. The tubes 72 and 74 are connected so as to provide for relative longitudinal movement between them. In other words, the conduit 48 can maintain fluid communication between rotating conduit connectors 58 and 62, even as the distance between the connectors gets shorter or longer. The inclusion of a telescoping conduit provides for even greater longitudinal travel for the manifold 22. As the manifold 22 reciprocates longitudinally in the tank 12, the conduits 46 and 48 will be moving and reorienting themselves to accommodate changes in the distance between conduits 40 and 24. In order to facilitate the movement of the conduits 46 and 48, it may be desirable to support one or more of them on rollers such as wheels 76 shown in FIG. 7 under the conduit 48.

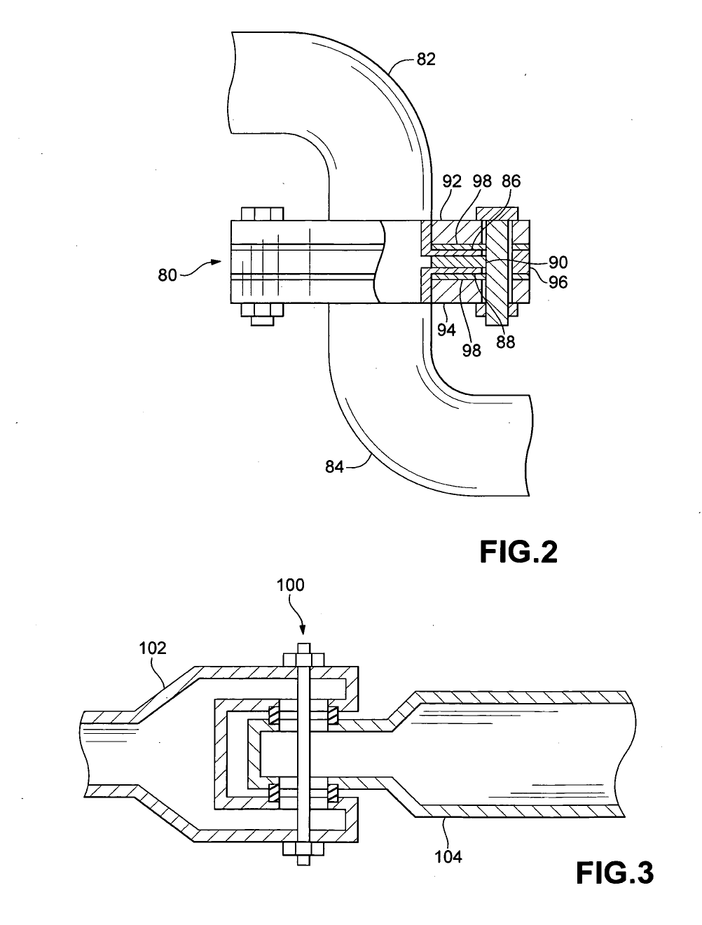

Turning now to FIG. 2, some details of a suitable rotating conduit connector are illustrated in reference to a connector indicated generally at 80. The connector 80 connects a conduit 82 to a conduit 84. Connected to the conduit 82 is a radially outwardly extending flange 86 and connected to the conduit 84 is a radially outwardly extending flange 88. A washer 90, preferably composed of UHMW polymer, is sandwiched between the flanges 86 and 88. An upper flange plate 92 and a lower flange plate 94 are held tightly against a spacer ring 96 by fasteners. Completing the sandwich are washers 98. One of the washers 98 is positioned between the flange 86 and the flange plate 92 and another one is positioned between the flange 88 and the flange plate 94. This construction maintains the axis of each of the conduits 82 and 84 aligned with each other while permitting relatively easy relative rotation between the conduits. In FIG. 2, it will be seen that the connector 80 permits relative rotation between the conduits 82 and 84 over a complete range of 360 degrees without interference between the conduits. In other words, the conduits 82 and 84 can be rotated relative to each other until laterally extending portions of the conduits 82 and 84 are vertically aligned, without interference therebetween. Laterally extending portions of the conduits 82 and 84 would be at different heights relative to, for example, a floor (not shown) below the connector 80.

Turning now to FIG. 3, another rotating conduit connector is indicated generally at 100. A conduit 102 and a conduit 104 are connected to each other through the connector 58 100 which allows for relative rotation as between the conduits 102 and 104. In this design, alignment of the axis of each of the conduits 102 and 104 is maintained but the flow path from conduit to conduit is a bit more tortuous owing to the fact that the fluid flow between conduits is in a direction that is transverse to the axis of each one of the conduits. It is also seen in FIG. 3 that the connector 100 does not permit relative rotation between the conduits 102 and 104 over a complete range of 360 degrees without interference between the conduits. In other words, the conduits 102 and 104 can only be rotated relative to each other so far before interference between them prevents further relative rotation.

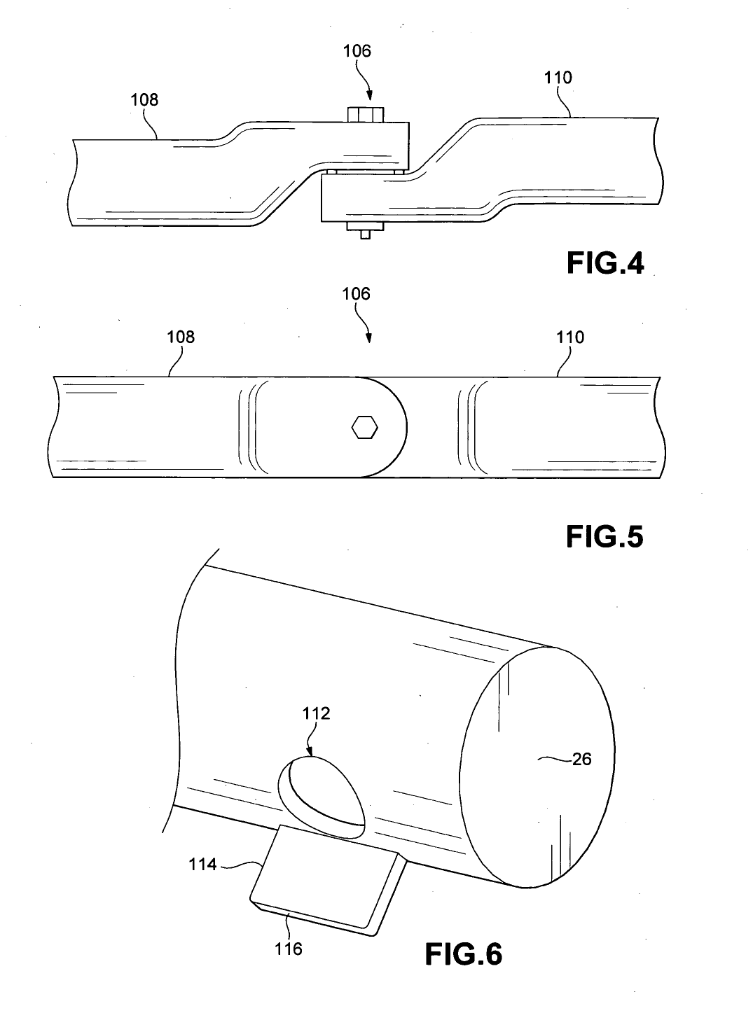

Turning now to FIGS. 4 and 5, a rotating conduit connector is indicated generally at 106. 64. A conduit 108 and a conduit 110 are rotatably connected to each other through the rotating conduit connector 106. It is seen in FIGS. 4 and 5 that the connector 106 does not permit relative rotation between the conduits 108 and 110 over a complete range of 360 degrees without interference between the conduits. In other words, the conduits 108 and 110 can only be rotated relative to each other so far until interference between them prevents further relative rotation.

An important aspect of the sludge removal system is the conduit arrangement by which a fixed sludge outlet conduit is connected to a moving inlet conduit. During sludge removal with the sludge removal apparatus of this invention, the inlet conduit 24 moves, with the manifold 22, longitudinally, but does not move laterally, in the tank 12. The sludge outlet conduit 40 remains fixed. In the sludge removal apparatus shown in FIGS. 1 and 7, sludge is conveyed from the moving manifold 22 to the outlet 40 by conduits 46 and 48. Rotating conduit connectors 52, 58 and 62 cooperate with the conduits 46 and 48 to maintain fluid communication between the conduits 24 and 40, and to accommodate changes in the distance between the outlet conduit 40 and the inlet conduit 24 due to the manifold 22 moving back and forth longitudinally in the basin 12. The conduits 46 and 48 reorient, as needed, to compensate for the varying distances between conduits 24 and 40 while maintaining fluid communication therebetween. In FIG. 1, conduit 46 has a fixed length and conduit 48 is a telescoping conduit with an inner tube 72 and an outer tube 74. In this configuration, scissor action between conduits 24 and 46, between conduits 46 and 48, and between conduits 48 and 40, combine with the variable length of conduit 48 to compensate for the varying distance between conduits 24 and 40. Other compensating conduit configurations are described below with reference to other Figs.

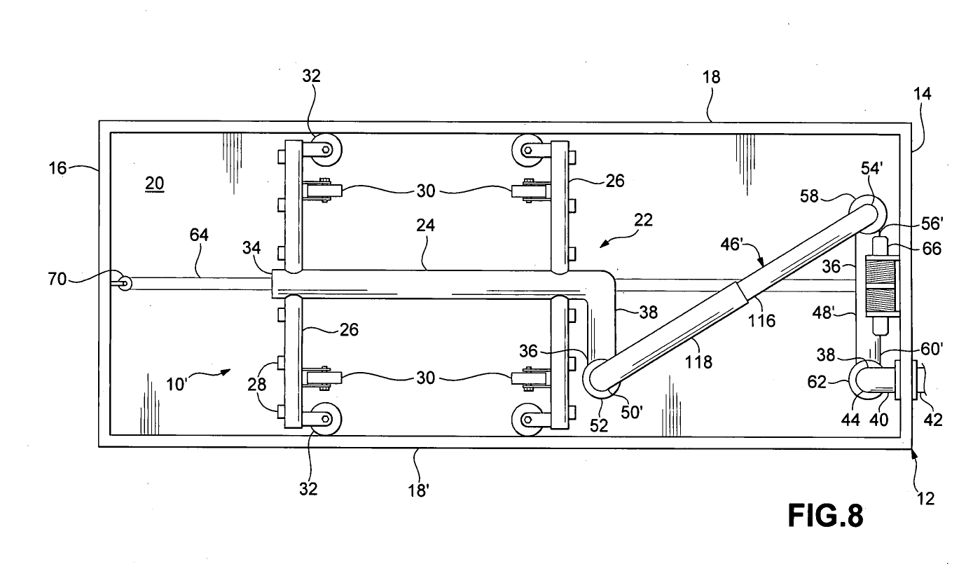

In a sludge removal system 10′ shown in FIG. 8, conduit 46′ has been substituted for conduit 46 in FIG. 1. Conduit 46′ is a telescoping conduit with a variable length. In addition, conduit 48′ has been substituted for conduit 48 in FIG. 1. Conduit 48′ has a fixed length and does not telescope. The conduits 46′ and 48′ compensate for the varying distances between conduits 24 and 40 while maintaining fluid communication therebetween. In FIG. 8, conduit 46′ is a telescoping conduit with an inner tube 116 and an outer tube 118, while conduit 48′ is a fixed length conduit. In this configuration, scissor action between conduits 24 and 46′, between conduits 46′ and 48′, and between conduits 48′ and 40, combine with the variable length of conduit 46′ to compensate for the varying distance between conduits 24 and 40 as the manifold 22 moves longitudinally, up and down the length of the tank 12.

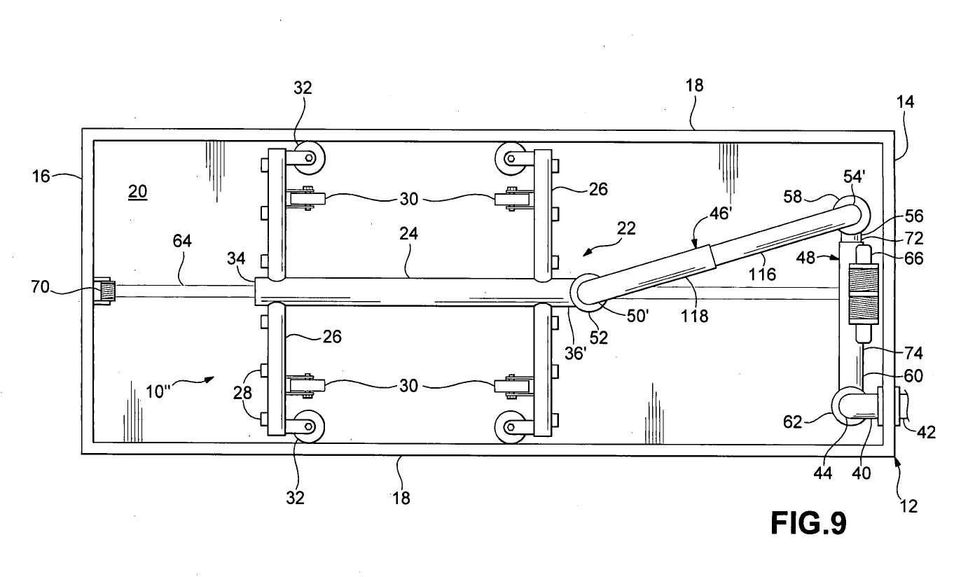

In a sludge removal system 10″ shown in FIG. 9, the telescoping conduit 46′ has been substituted for conduit 46 in FIG. 1 and it is combined with telescoping conduit 48. The conduits 46′ and 48 compensate for the varying distances between conduits 24 and 40 while maintaining fluid communication therebetween. In the FIG. 9 configuration, scissor action between conduits 24 and 46′, between conduits 46′ and 48, and between conduits 48 and 40, combine with the variable lengths of conduits 46′ and 48 to compensate for the varying distance between conduits 24 and 40 as the manifold 22 moves longitudinally, up and down the length of the tank 12.

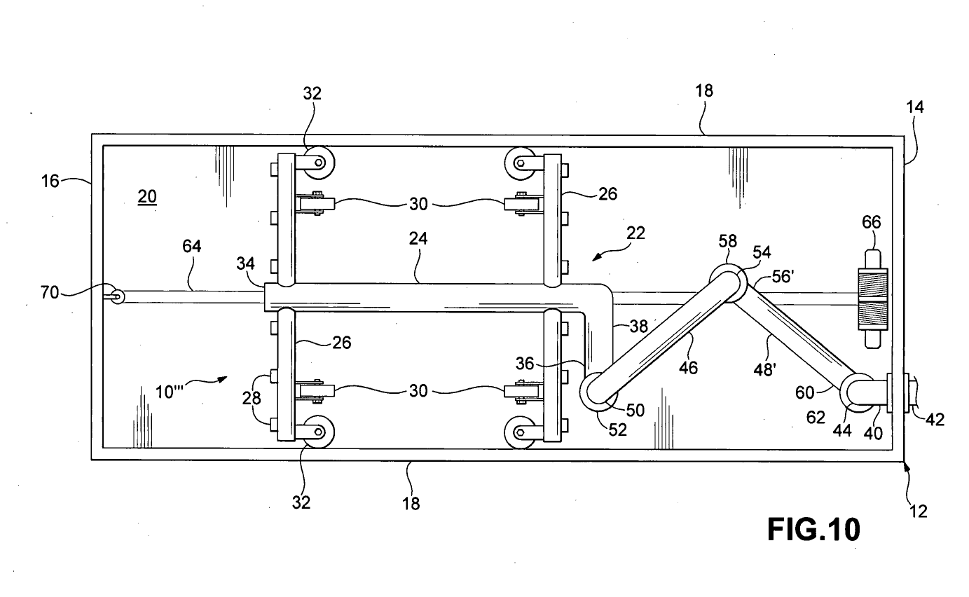

In a sludge removal system 10′″ shown in FIG. 10, conduit 48′ has been substituted for conduit 48 in FIG. 1. Conduit 46 and conduit 48′ have fixed lengths and they do not telescope. Nonetheless, the conduits 46 and 48′ compensate for the varying distances between conduits 24 and 40 while maintaining fluid communication therebetween. In the conduit configuration illustrated in FIG. 10, scissor action between conduits 24 and 46, between conduits 46 and 48′, and between conduits 48′ and 40 combine to compensate for the varying distance between conduits 24 and 40 as the manifold 22 moves back and forth within the basin.

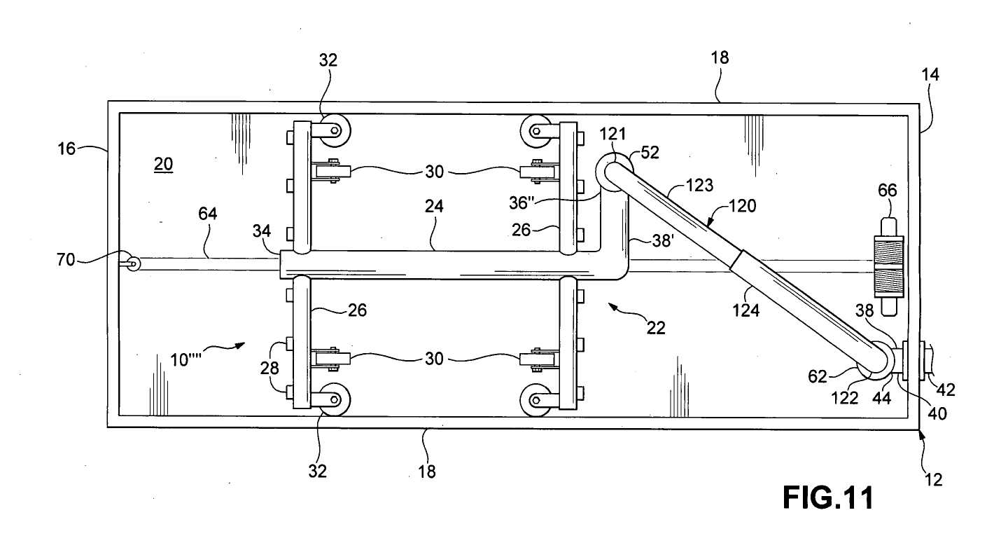

In a sludge removal system 10″″ shown in FIG. 11, a single conduit 120 has been substituted for both of the conduits 46 and 48 in FIG. 1. The conduit 120 has a first end 121 that is in fluid communication with the rotating conduit connector 52 and a second end 122 that is in fluid communication with the rotating conduit connector 62. The conduit 120 is a telescoping conduit with a variable length and it comprises an inner tube 123 and an outer tube 124. The conduit 120 compensates for variations in the distance between conduits 24 and 40 while maintaining fluid communication therebetween. In the conduit configuration shown in FIG. 11, scissor action between conduits 24 and 120, and between conduits 120 and 40, combine with the variable length of conduit 120 to compensate for the varying distance between conduits 24 and 40.

In addition to conduit configurations for delivering sludge to a fixed outlet conduit, the invention is concerned with drawing sludge from the tank 12 into sludge removal apparatus. Some details about the manifold arm conduits 26 are illustrated in FIG. 6. A plurality of sludge entry openings, one of which is indicated at 112 in FIG. 6, are provided along the length of the manifold arm conduits 26 so that sludge in the tank or basin 12 can enter the sludge removal apparatus 10 by passing through the openings 112 into the manifold arm conduits 26. Sludge paddles 114 (reference number 28 in FIGS. 1 and 7) extend generally downwardly from the manifold arms 26, below the openings 112, so that a lower edge 116 of the paddles 114 is adjacent to the tank bottom 20, when the manifold 22 is in the tank 12. As the manifold 22 moves longitudinally from end to end in the tank 12, the paddles 114 direct sludge upwardly from the tank floor 20 into the manifold arm conduit openings 112. In the configuration show in FIG. 6, the openings 112 are on the side of the manifold arm conduits 26, as opposed to the bottom of the conduits 26. The paddles 114 are attached to the manifold arm conduits between the openings and the bottom of the manifold arm conduits.

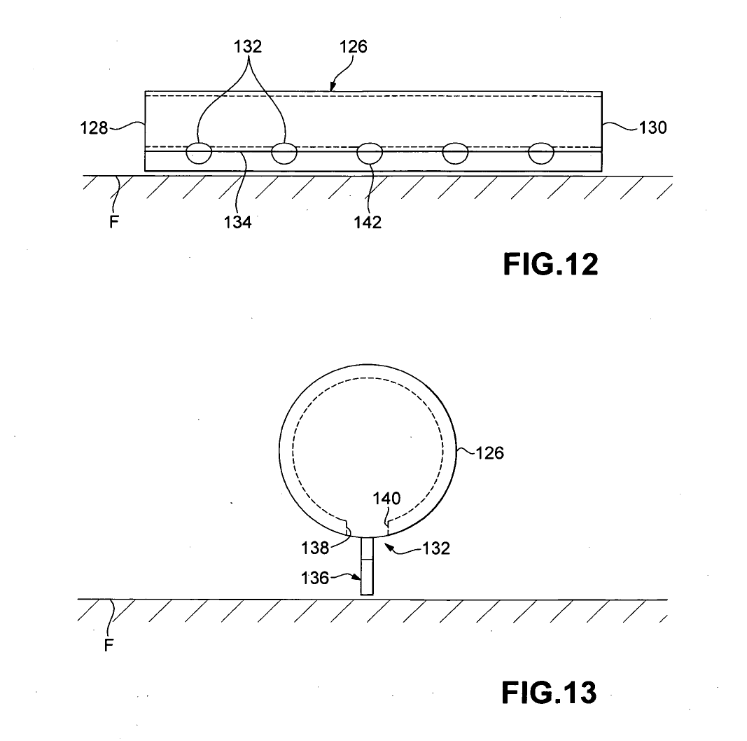

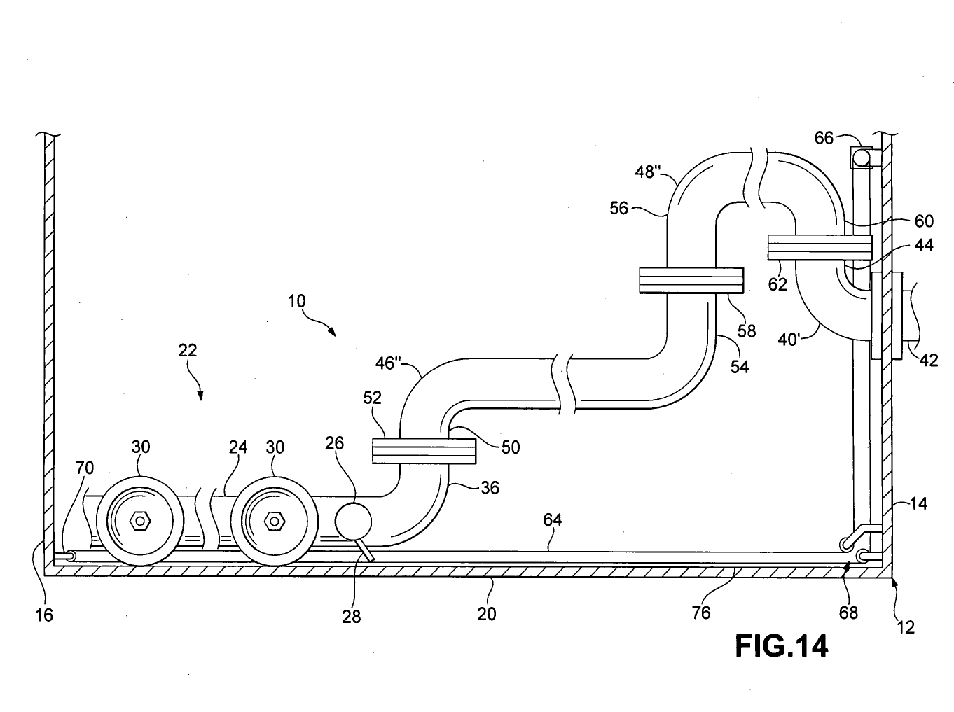

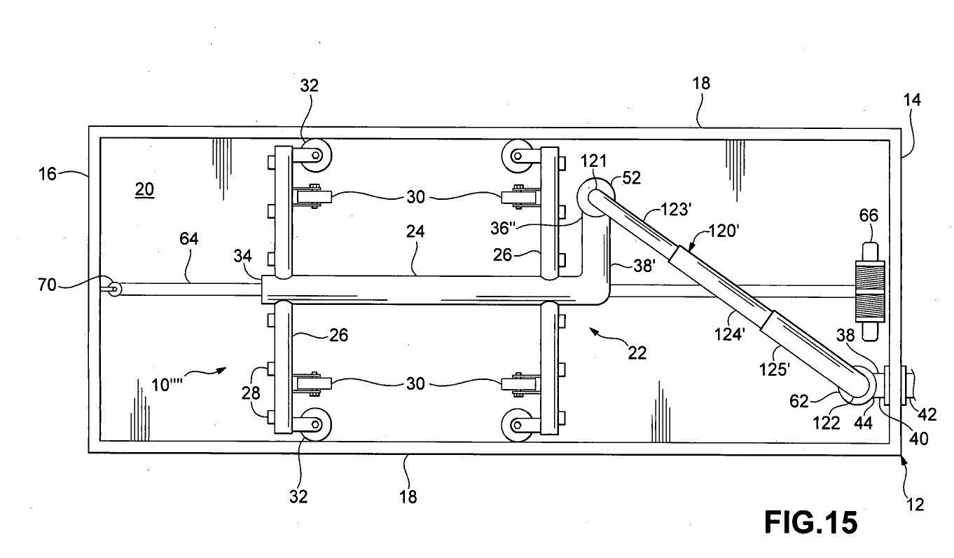

An alternative manifold arm conduit construction is illustrated in FIGS. 12 and 13. A manifold arm conduit 126 comprises a first closed end 128 and a second end 130 which, in use, would be in communication with a manifold conduit. In operation, the manifold arm conduit 126 would be supported above a floor F of a basin. The conduit 126 is cylindrically shaped and it is provided with a plurality of sludge entry openings indicated generally at 132. The openings 132 are aligned and they are positioned on the bottom 134 of the conduit 126. In other words, when the conduit 126 is mounted on a manifold in a clarifier tank, the openings 132 face downwardly towards the floor of the tank. A wiper vane 136 is supported on the bottom 134 of the conduit 126 so that, in use, the wiper 136 is oriented generally vertically and it extends from the conduit 126 towards the floor F of the tank. The wiper vane 136 bridges the sludge entry openings 132 so that, as seen in FIG. 13, one edge 138 of the opening 132 is on one side of the wiper vane 136 and another edge 140 of the opening 132 is on the opposite side of the wiper vane 136.

Openings 142 are formed along an upper edge of the wiper vane 136, that is, the portion of the wiper vane 136 that is connected to the conduit 126. The openings 142 are spaced along the wiper vane 136 so that they register with corresponding openings 132 in the conduit 126. As illustrated in FIG. 13, this provides a bi-directional feature so that the conduit 126 is equally effective at withdrawing sludge from adjacent to the floor F of a tank whether it is moving left to right in FIG. 13 or it is moving right to left.

A further conduit arrangement is illustrated in FIG. 14. A portion of manifold conduit 24 extends in a generally horizontal direction at a first height from the tank bottom 20 and the manifold 24 extends upwardly from that horizontal portion to a first rotating conduit connector 52. A central portion of conduit 46″ extends in a generally horizontal direction at a second height from the tank bottom 20. A portion of the conduit 46″ near the end 50 extends downwardly from that horizontal portion to the first rotating conduit connector 52 while a portion of the conduit 46″ near the end 54 extends upwardly from that horizontal portion to the second rotating conduit connector 58. A central portion of conduit 48″ extends in a generally horizontal direction at a third height from the tank bottom 20. A portion of the conduit 48″ near the end 56 extends downwardly from that horizontal portion to the second rotating conduit connector 58 while a portion of the conduit 48″ near the end 60 extends downwardly from that horizontal portion to the third rotating conduit connector 62. A portion of the sludge outlet conduit 40′ extends in a generally horizontal direction at a fourth height from the tank bottom 20. A portion of the conduit 40′ near the end 44 extends upwardly from that horizontal portion to the third rotating conduit connector 62.

In the system shown in FIG. 14, the second, third and fourth heights are each different and they are sufficiently different that there is no interference between conduits 40′, 46″ and 48″, regardless of the degree of relative rotation between any of them. Thus, the conduits 40′, 46″ and 48″ can assume positions where they are all snug up very close to the wall 14, so that portions of them are vertically aligned, without interference between any of them.

In the system shown in FIG. 14, the first, second, third and fourth heights are each different and they are sufficiently different that there is no interference between conduits 24, 40′, 46″ and 48″, regardless of the degree of relative rotation between any of them. Thus, while conduits 24 and 46″ are connected, the conduits 40′, 46″ and 48″ can assume positions where they are all snug up very close to the wall 14, so that portions of them are vertically aligned, without interference between any of them. When the conduits 40′, 46″ and 48″ are positioned so that they are all snug up very close to the wall 14, the end 36 of conduit 24 can (and will be) snug up very close to the wall 14. In this state, portions of each of the conduits 24, 40′, 46″ and 48″ are vertically, aligned.

The system shown in FIG. 14 also provides an arrangement where the first, second and third rotating conduit connectors 52, 58 and 62 are each at a different height from the floor 20 of the tank. In some configurations of conduits in a sludge removal system according to the invention, the different heights of the rotating conduit connectors can also serve to prevent interference therebetween.

In FIG. 15, a variation of the system shown in FIG. 11 is illustrated. The telescoping conduit 120′ has been substituted for the conduit 120. The conduit 120′ comprises three telescoping conduit sections, namely section 123′, 124′ and 125. The configuration shown in FIG. 15 for the conduit 120′ provides for a continuous fluid connection between conduit 24 and conduit 40 over a longer course of travel of the manifold 22, than the conduit 120 in FIG. 11.

Thus, apparatus comprised of rigid components is provided which will maintain fluid communication between two spaced conduits where one of the conduits is stationary and the other conduit is part of a longitudinally movable manifold, even while the manifold moves backward and forward, longitudinally.

It will be apparent to the artisan that the present invention is susceptible of numerous variations from the details described above and illustrated in the various drawing figures. Therefore, notice is hereby given that the invention is not to be limited by the terms of the foregoing description but only by the spirit and scope of the invention as described above and defined in the claims appended hereto.

We claim:

1. Apparatus for removing sludge from a clarifier tank having a bottom, said apparatus comprising
a manifold supported above the bottom of the tank for reciprocating movement between a first position and a second position in the tank,
a manifold conduit having a first end,
at least one sludge inlet that is associated with said manifold and that is in fluid communication with said manifold conduit,
a sludge outlet,
a first conduit having first and second ends,
a second conduit having first and second ends,
a first connector rotatably and fluidically connecting said first end of said manifold conduit to said first end of said first conduit,
a second connector rotatably and fluidically connecting said second end of said first conduit to said first end of said second conduit,
a third connector rotatably and fluidically connecting said second end of said second conduit to said sludge outlet,
wherein, when the manifold is moving between said first position and said second position, said first conduit rotates relative to said manifold conduit and said first conduit rotates relative to said second conduit and said second conduit rotates relative to said sludge outlet, and wherein sludge taken in through said at least one sludge inlet is delivered to and through said sludge outlet.

2. The apparatus claimed in claim 1 wherein at least one of said first and second conduits is a telescoping conduit.

3. The apparatus claimed in claim 1 wherein at least two of said first and second conduits are telescoping conduits.

4. The apparatus claimed in 2 wherein said telescoping conduit comprises at least three telescoping conduit sections.

5. The apparatus claimed in claim 1 wherein at least a portion of said manifold conduit is supported at a first height above the tank floor, at least a portion of said first conduit is supported at a second height above the tank floor and at least a portion of said second conduit is supported at a third height above the tank floor, and wherein said first, second and third heights are controlled so that there is clearance such that said at least one portion of each of said manifold conduit, said first conduit and said second conduit can be vertically aligned without interference.

6. Apparatus for removing sludge from a clarifier tank having a bottom, said apparatus comprising
a manifold supported above the bottom of the tank for reciprocating movement between a first position and a second position in the tank,
a manifold conduit having a first end,
at least one sludge inlet that is associated with said manifold and that is in fluid communication with said manifold conduit,
a sludge outlet,
a first conduit having first and second ends,
a second conduit having first and second ends,
a first connector rotatably and fluidically connecting said first end of said manifold conduit to said first end of said first conduit,
a second connector rotatably and fluidically connecting said second end of said first conduit to said first end of said second conduit,
a third connector rotatably and fluidically connected to said second end of said second conduit,
wherein, when the manifold is moving between said first position and said second position, said first conduit rotates relative to said manifold conduit and said first conduit rotates relative to said second conduit and
wherein sludge taken in through said at least one sludge inlet is delivered to and through said sludge outlet.

7. The apparatus claimed in claim 6 wherein at least one of said first and second conduits is a telescoping conduit.

8. The apparatus claimed in claim 6 wherein at least two of said first and second conduits are telescoping conduits.

9. The apparatus claimed in 7 wherein said telescoping conduit comprises at least three telescoping conduit sections.

10. The apparatus claimed in claim 6 wherein at least a portion of said manifold conduit is supported at a first height above the tank floor, at least a portion of said first conduit is supported at a second height above the tank floor and at least a portion of said second conduit is supported at a third height above the tank floor, and wherein said first, second and third heights are controlled so that there is clearance such that said at least one portion of each of said manifold conduit, said first conduit and said second conduit can be vertically aligned without interference.

11. Apparatus for removing sludge from a clarifier tank having a bottom, a first wall and an opposed second wall, said apparatus comprising
a manifold supported above the bottom of the tank for reciprocating movement between a first position and a second position in the tank,
a manifold conduit having a first end,
at least one sludge inlet that is associated with said manifold and that is in fluid communication with said manifold conduit,
a sludge outlet,
at least one conduit fluidically connecting said first end of said manifold conduit to said sludge outlet,
wherein said at least one sludge inlet comprises
an opening in said manifold that faces the tank bottom when said manifold is supported above the tank bottom,
a vane having a first side, a second side, a first edge, a second edge and at least one recess in said second edge of said vane, said vane being supported relative to said manifold so that, when said manifold is supported above the tank bottom,
said first side of said vane faces said first tank wall,
said second side of said vane faces said second tank wall,
said vane extends from said manifold downwardly towards the tank bottom,
said at least one second edge recess registers with said opening in said manifold
a portion of said opening in said manifold is between said first side of said vane and said first tank wall,
a portion of said opening in said manifold is between said second side of said vane and said second tank wall.

12. The apparatus claimed in claim 11 wherein said at least one recess in said second edge of said vane is defined by a generally semi-circular edge.

13. The apparatus claimed in claim 11 wherein said opening in said manifold is defined by a generally circular edge.

14. The apparatus claimed in claim 11 wherein said portion of said opening in said manifold that is between said first side of said vane and said first tank wall, and said portion of said opening in said manifold that is between said second side of said vane and said second tank wall, are substantially equal in area.

15. The apparatus claimed in claim 11 wherein said manifold comprises said manifold conduit and at least one manifold arm extending outwardly from said manifold conduit and in fluidic communication therewith, and wherein said at least one sludge inlet comprises an opening in said manifold arm that faces the tank bottom when said manifold is supported above the tank bottom

16. A sludge inlet manifold for apparatus for removing sludge from a clarifier tank having a bottom, said inlet comprising
a manifold supported above the bottom of the tank for movement between a first position and a second position in the tank,
a manifold conduit,
at least one sludge inlet that is associated with said manifold and that is in fluid communication with said manifold conduit,
wherein said at least one sludge inlet comprises
an opening in said manifold that faces the tank bottom when said manifold is supported above the tank bottom,
a vane having a first side, a second side, a first edge, a second edge and at least one recess in said second edge of said vane, said vane being supported relative to said manifold so that, when said manifold is supported above the tank bottom,
said first side of said vane faces in a first direction,
said second side of said vane faces in a second direction opposite said first direction,
said vane extends from said manifold downwardly towards the tank bottom,
said at least one second edge recess registers with said opening in said manifold
a portion of said opening in said manifold extends from said first side of said vane in said first direction,
a portion of said opening in said manifold extends from said second side of said vane in said second direction.

17. The apparatus claimed in claim 16 wherein said at least one recess in said second edge of said vane is defined by a generally semi-circular edge.

18. The apparatus claimed in claim 16 wherein said opening in said manifold is defined by a generally circular edge.

19. The apparatus claimed in claim 16 wherein said portion of said opening in said manifold that extends from said first side of said vane in said first direction and said portion of said opening in said manifold that extends from said second side of said vane in said second direction, are substantially equal in area.

20. The apparatus claimed in claim 16 wherein said manifold comprises said manifold conduit and at least one manifold arm extending outwardly from said manifold conduit and in fluidic communication therewith, and wherein said at least one sludge inlet comprises an opening in said manifold arm that faces the tank bottom when said manifold is supported above the tank bottom.
